(19) United States
(12) Patent Application Publication
(10) Pub. No.: US 2007/0126565 A1
(43) Pub. Date: Jun. 7, 2007

(54) Process for monitoring blind angle in motor vehicles

(75) Inventors: Stefan Hahn, Ulm (DE); Carsten Knoeppel, Stuttgart (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/588,477

(22) Filed: Oct. 27, 2006

(30) Foreign Application Priority Data
Nov. 16, 2005 (DE) 10 2005 054 972.1
Oct. 27, 2005 (DE) DE10 2005051803.6

(51) Int. Cl. B60Q 1/00

(52) U.S. Cl. 340/435

(57) ABSTRACT

Driver assist systems for monitoring blind zones are known from the state-of-the-art. The requirements placed upon the reliability of this type of driver assist system is very high, and as a result these systems known from the state-of-the-art frequently trigger false warnings. For this reason, a process for blind zone monitoring in motor vehicles is proposed, wherein information is detected from the vehicle environment in order to recognize other traffic participants. Under the condition of an intent to carry out a lane change and the presence of other traffic participants in the blind zone of the own vehicle, a driver warning is emitted. Before a driving warning can however occur a check is carried out with respect to whether a lane change can even be carried out on the basis of the traffic infrastructure. Driving warnings are suppressed in the case that as a result of the check a lane change is not possible or permissible.

### BACKGROUND OF THE INVENTION

1. Field of the Invention

The invention concerns a process for monitoring the blind angle-area or zone in motor vehicles.

2. Description of Related Art

Driver assistance systems, in which environmental information is detected using image sensors, are well known according to the state-of-the-art. For example, driver assistance systems for monitoring blind zones are known, in which at least one image producing sensor is provided on each side of the vehicle for monitoring the side areas of the motor vehicle. The detected environment information is evaluated by means of a computer unit and is displayed, for example, on an image display in the vehicle passenger compartment, or, in the case of assessment of a possible imminent danger, an acoustic driving warning may for example emitted. With a driver assistance system of this type for monitoring the blind zone, it is possible for the driver to also monitor those respective environment areas which he cannot view with conventional motor vehicle external mirrors. For this type of driver assistance system, conventionally very high demands are placed on precision and reliability, so that the driver can reliably be warned in advance of imminent danger.

In DE 10352967A1 a driver assistance system for supporting the lane change of a motor vehicle is shown, wherein a warning is emitted in the case of a present danger situation. The driver assistance system should be characterized thereby, that for increasing the driving comfort warnings are suppressed without however comprising the safety. In order to decide whether a warning should be suppressed, at least the present vehicle condition is taken into consideration, for example the position of the turn signals. It is however also possible that environmental information is taken into consideration for the suppression of a warning. A warning is suppressed in the case that the location of the vehicle relative to certain features in the environment of the vehicle necessitate this. For example, in the case that the distance between vehicle and a lane marker is less than a predetermined threshold value, or the lane marker has been crossed over.

The invention is thus concerned with a task of providing a further process for monitoring the blind zone of a vehicle of the type wherein information can be detected from the vehicle environment in order to recognize other traffic participants, and wherein a driver warning is emitted, which warns the driver in reliable manner of threatening danger in the case of intent of carrying out a lane change and presence of other traffic participants in the blind zone of the own vehicle.

### SUMMARY OF THE INVENTION

In accordance with the invention the task is solved by a process of the above described type, in which prior to a lane change a check is carried out with respect to whether it is possible to carry out a lane change on the basis of the traffic infrastructure, and wherein a driver warning omitted in the case that the result of the check is that a lane change is not possible. Advantageous embodiments and further developments are set forth in the dependent claims.

### DETAILED DESCRIPTION OF THE INVENTION

In accordance with the invention a process for monitoring the blind zone in motor vehicles is provided, wherein information from the vehicle environment is detected in order to recognize other traffic participants. In the framework of the process, in the case of the existence of the intention for carrying out a lane change and in the presence of another traffic participant in the blind zone of the own vehicle a driver warning is emitted. In an inventive manner, prior to warning, a check is made to the extent as to whether a lane change may be carried out on the basis of the traffic infrastructure. A driver warning is omitted in the case that the result of the checking is that a lane change is not possible. With the invention it is possible for the first time to warn the driver in a safe and reliable manner of imminent danger. As a result of the checking of the ability to carry out a lane change depending upon the traffic infrastructure prior to a warning, it is possible with the invention in a particularly advantageous manner to avoid false alarms or irrelevant warnings. Irrelevant warnings unnecessarily detract the driver from his actual tasks. Therein the checking as to whether a lane change can be carried out takes place either continuously or in certain time intervals. In connection with the invention the term traffic infrastructure refers to both the presence of structures and well as the indicated traffic regulations for a segment of road.

In connection with the invention the blind zone is not only limited to those areas which are located behind the vehicle or to the side of the vehicle and which cannot be seen by the rear view mirror. Rather, the blind zone includes in accordance with this invention also remote areas behind the vehicle or to the side of the vehicle. Therein for example vehicles rapidly approaching from behind or from the side, which have a distance of 30-40 meters to the own vehicle, can already trigger a warning signal in conjunction with the inventive process. The detection of environmental areas for recognition of traffic participants and the traffic infrastructure occurs for example using image sensors. These could be for example one or more tail end and/or front cameras. It is however for example alternatively or supplementally possible to employ one or more lidar sensors. The person of ordinary skill is also familiar with various image sensors which can be employed not only during the day but also in the dark.

In a particularly advantageous manner, at the time a vehicle lane change is being contemplated, it is determined whether an adjacent lane is present, to which a lane change can or may be executed. In the case of a lane change the driver is only warned in the case that there exists an adjacent lane onto which a lane change can be executed. For example, a suppression of the driver warning with regard to the left blind zone occurs in the case that the own vehicle is located on the left most lane, since to the left of the vehicle no further lane is present and other vehicles cannot be overtaken there. With regard to the right blind zone there occurs in this case preferably still a driver warning, since in various countries it is permitted to pass to the right. There occurs in this case also essentially a suppression of the driver warning with regard to that respective blind zone which is located on that side of the vehicle, upon which adjacent to the own lane no further lane is present. Alternatively thereto it is however also possible that a suppression of the driver warning is simultaneously directed to both the left and the right blind zone of the vehicle. Whether a suppression of the driver warning is with respect to only the left, or with respect to the left and the right, blind zone, this can be determined for example by a driver input. Further for example driver warnings are suppressed with respect to the right blind zone, in the case that the own vehicle is located on the outer most right lane and to the right adjacent no additional lane exists. Also in this case the suppression of the driver warning can be with regard to only the left or however also the left and the right blind zone. The suppression of the driver warnings can be on this be with reference to warnings of other driver assistance systems.

In a further advantageous manner it is determined by means of image information and/or information from a navigation system, whether an adjacent lane is present, on to which a lane change can be made. Image information is supplied in this case for example by a vehicle side mounted camera. On the basis of the camera images it can be directly determined whether an adjacent lane is present. For example, with regard to evaluation, those image processing processes can be employed which make it possible to analyze textures or movement information, for example by means of the optical flow process. Besides this, many object recognition processes are known, which are based on a classification or image segmentation. In addition or alternatively it can be determined by means of information from a navigation system whether an adjacent lane is present. In digital road maps information regarding the number of lanes is provided and on the basis of GPS information it can be determined at which precise position the own vehicle is located with reference to these lanes. In the case that adjacent to the lane upon which the own vehicle is located no further lanes are present, there occurs then a suppression of driver warnings, in order in gainful manner not to distract the driver unnecessarily with false alarms.

There is also the possibility that it is determined on the basis of lane markings and/or traffic signs whether an adjacent lane is present, on to which a lane change can be made. Lane markings are detected in association with the invention preferably by means of image providing sensors. There exists for example however also the possibility, that information regarding lane markings is included in the navigation data wherein in addition to the course of the lane markings supplementally information can be stored regarding their configuration. At the same time it can also be detected by. means of image providing sensors the progression and the configuration of the lane markings. From this there is determined, besides the existence or absence of a lane marking, their configuration is distinguished such as for example dashed, continuous, wide or narrow. In addition or alternatively thereto there is an association with the invention traffic signs are detected by means of image providing sensors and/or on the basis of navigation data. Using the information derived from lane markings and/or traffic signs it can then be determined whether an adjacent lane exists. In the case that it is determined that no adjacent lane exists, then driver warnings are suppressed in order not to unnecessarily distract the driver.

In a further advantageous manner for checking the possibility of a lane change in advantageous manner traffic laws are consulted. On the basis of laws regarding vehicular traffic it can be checked in advantageous manner whether a lane change is even permitted. A driver warning is omitted in the case that the result of the checking is that a lane change is not permitted. Regulations regarding vehicular traffic are consulted in advantageous manner in the form of image information and/or information from a navigation system. For example traffic signs, topology of the course of the road, road markings or lane markings can be detected by using an image sensor, wherein for example in the case of a continuous lane marking a lane change is not permitted and thus a presumption can be made that a lane change is not contemplated. The driver warning is thus suppressed in this case so that the driver is not unnecessarily distracted. At the same time regulations regarding the street traffic are detected on the basis of traffic signs wherein those types of information could also be contained in digital maps from a navigation system. Driver warnings are suppressed in advantageous manner in the framework of the invention in the case that a lane change is not possible or in the case that a lane change is not permitted. In a further advantageous manner driver warnings can however also be suppressed only in the case that both of the above-mentioned conditions are satisfied.

Further characteristics and advantages of the invention can be seen from the following description of preferred embodiments on the basis of the figures, wherein there is shown:

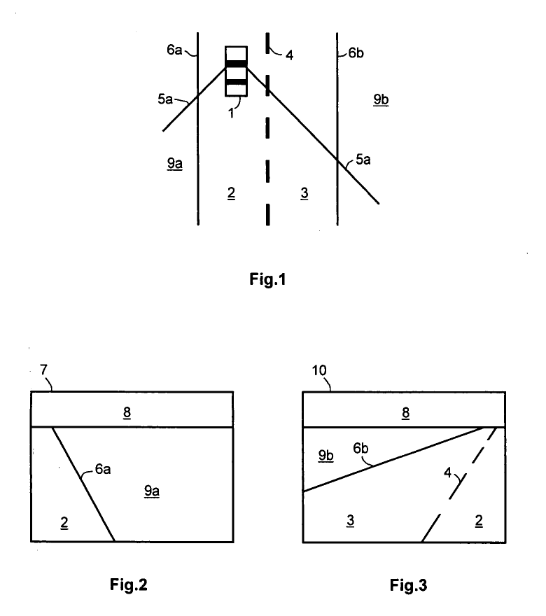

FIG. 1 a traffic scene with a vehicle using the inventive process

FIG. 2 an image segment of an environment area detected with a first blind zone camera

FIG. 3 an image segment of a environment area detected with a further blind zone camera

In FIG. 1 a traffic scene is shown with a vehicle 1 employing the inventive process. The vehicle 1 is located on a road with a left lane 2 and a right lane 3, which are separated from each other by a lane marking 4. The vehicle 1 includes a lane change assist, which warns the driver in the case that during a lane change a danger of collision with other traffic participants or the traffic infrastructure exists. The vehicle 1 includes for this on the left and the right side respectively one blind zone camera, not shown in the figure, integrated in the vehicle external mirrors. In the figure there is shown respectively one virtual boundary line 5a, 5b of the detection area on the left or as the case may be right side located camera. The virtual boundary lines 5a, 5b form therein the outer boundary of the detection area of the respective camera. An inner boundary of the inventive area is formed on each side by the left and right vehicle outer side. With the blind zone camera other traffic participants in the blind zone of the respective vehicles 1 are recognized and by evaluation of the image information their distance as well as relative movement are determined relative to the own vehicle 1 for example by means of the optical flow method. On the basis of these values then the danger potential is derived, wherein the danger potential increases with increasing relative speed of approaching vehicles. Depending upon the danger potential as well as the intention for carrying out a lane change then there occurs a driver warning. The intention of carrying out a lane change is therein determined for example on the basis of the actuation of the turn signal indicator or the direction of view or attention of the driver. Prior to a driver warning there occurs however a checking with respect to whether on the basis of the traffic infrastructure a lane change is even legally permitted. For this, it is checked on the basis of the road edge markings 6a, 6b, whether additional lanes are located besides the lanes 2, 3 also. Since in this example next to the lanes 2, 3 in the areas 9a, 9b no further lanes are located, driver warnings occur only in the case of a change from the lane 2 to lane 3 or the reverse from lane 3 to lane 2. Otherwise, driver warnings are suppressed, in order not to distract the driver with unnecessary false warnings. The driver warnings can be for example in an optical, acoustic or haptic mode. Therewith the driving safety and driving comfort are increased during blind zone monitoring.

FIG. 2 an image segment 7 is shown of a environmental area detected with a blind zone camera. The image segment 7 shows in particular the environment area detected with a blind zone camera located on the left vehicle external side. In the image segment 7 a part of the lane 2 from FIG. 1 can be seen, which is delineated by a road edge marking 6a from the environment area 9a, in which no further road markings are present. In addition, in the image segment 7 a horizon 8 can be seen.

In FIG. 3 an image segment 10 of a environment area detected with a further blind zone camera is shown. The image segment 10 shows in particular an environment area detected with a blind zone camera mounted on the right side of the vehicle. Within the image segment 10 a segment of the lane 3 as well as a part of the lane 2 can be seen. The lanes 2, 3 are separated from each other by a lane marking 4 characterized by a dashed configuration. In addition a continuous road edge marking 6b is present, which serves for delineation of the lane 3. The road edge marking 6b thereby separates the lane 3 from the adjacent environment area 9b in which no further lanes exist. In addition a horizon 8 can be seen in the image segment 10.

### REFERENCE NUMBER LIST

1 Vehicle
2,3 Lane
4 Lane Markings
5a, 5b Virtual Boundary Line
6a, 6b Road Edge Markings
7, 10 Image Segment
8 Horizon
9a, 9b Environment Area

Now that the invention has been described, I claim:

1. A process for blind zone monitoring in motor vehicles, wherein information is detected from the vehicle environment in order to recognize other traffic participants and wherein, upon the condition of intent to carry out a lane change and the presence of other traffic participants in the blind zone of the own vehicle a driver warning is emitted, wherein prior to warning a check is carried out with respect to whether it is possible or permissible to carry out a lane change on the basis of the traffic infrastructure, and wherein a driver warning omitted in the case that it is determined as a result of the check is that a lane change is not possible.

2. A process according to claim 1, wherein for checking the permissibility of a lane change it is determined whether an adjacent lane is present, into which a lane change can be carried out.

3. A process according to claim 2, wherein on the basis of image information and/or information from a navigation system it is determined whether an adjacent lane is present, on to which a lane change can be carried out.

4. A process according to claim 2, wherein it is determined on the basis of the lane markings and/or traffic signs whether an adjacent lane exists into which a lane change can be carried out.

5. A process according to the one of the preceding claims, wherein for checking the permissibility of a lane change traffic regulations regarding road traffic are consulted.

6. A process according to claim 5, wherein regulations regarding road traffic in the form of image information and/or information from a navigation system are consulted.
